(19) United States
(12) Patent Application Publication
(10) Pub. No.: US 2006/0042019 A1
(43) Pub. Date: Mar. 2, 2006

(54) Method of treating polyester fabrics

(75) Inventors: Joe Jump, Raleigh, NC (US); Stephanie McCloskey, Wake Forest, NC (US)

Correspondence Address: NOVOZYMES NORTH AMERICA, INC., 500 FIFTH AVENUE, SUITE 1600, NEW YORK, NY, 10110, US

(73) Assignee: Novozymes North America, Inc., Franklinton, NC (US)

(21) Appl. No.: 10/538,756

(22) PCT Filed: Dec. 22, 2003
(86) PCT No.: PCT/US03/41020

§ 371 Date: Jun. 10, 2005

Related U.S. Application Data
(60) Provisional application No. 60/436,073, filed on Dec. 23, 2002.

(51) Int. Cl. C11D 3/00

(52) U.S. Cl. 8/115.51

(57) ABSTRACT

This invention relates to a method of reducing the pilling propensity or color clarity of polyester containing fabrics and/or garments, which method comprises treating the fabric with a polyester hydrolytic enzyme without the presence of a detergent.

### TECHNICAL FIELD

This invention relates to a method of reducing the pilling propensity and/or improves the color clarity of polyester fabrics and/or garments, which method comprises treating the fabric with a polyester hydrolytic enzyme without the presence of a detergent. The invention also relates to a method of bio-polishing polyester containing fabrics and garments.

### BACKGROUND ART

Poly(ethylene terephthalate) fibers accounts for the main part of the polyester applied by the textile industry. The fibers are produced by, e.g., poly-condensation of terephthalic acid and ethylene glycol, and drawing of fibers from a melt.

Because of its strength, polyester fabrics and/or garments are subject to pill formation, and possibly the most important of the cloth-finishing processes applied to polyester staple-fibre materials are those designed for control of pilling. All staple-fibre materials tend to form small balls or “pills” of entangled fibres at the cloth surface, when subjected to mild abrasion during wash and wear. If the fabric contains a substantial proportion of fibres having high resistance to flexural abrasion, the pills may be retained on the surface of the cloth in sufficient numbers to produce an unpleasant handle and appearance.

According to Hatch in Textile Science (St. Paul: West Publishing Company, 1993. pages 52-53, 218, 420) the mechanism of pilling is as follows: i) Mechanical action causes fibers to migrate out of the fabric body to the surface, ii) Further action causes the surface fibers to rotate around other protruding fibers forming pills, iii) Additional action may continue to form more pills or to sever fibers anchoring pills. The pilling propensity of the fabric depends on the surface fuzz formation, the rate of fuzz entanglement, and finally the rate of pills breaking off. The rate of the pills breaking off is directly related to the tenacity of the anchor fibers.

Bio-polishing is a finishing process where a textile fiber or yarn is treated with an enzyme to impart properties such as anti-pilling, softness and smoothness. This concept was initially developed in Japan where the first experiments were performed on cotton woven fabrics using cellulases.

Pilling prevention is an ongoing challenge for manufacturers of cotton, polyester and blended fabrics. There is no simple solution to the problem of pilling. In the textile industry, polyester fibers are produced as medium- and high-tenacity filament yarns and as staple fibers of various lengths and fiber color to suit the kind of spinning machinery found in the textile trade. Staple fibers are usually drawn to give medium tenacities, but may be spun from polymers of lower average molecular weight to give improved “pilling” performance at the expense of some loss in abrasion resistance. Also, the finisher may reduce the pilling propensity of a fabric by the removal of protruding hairs from the surface of the cloth and by heat treatment to reduce the tendency of the fibres to migrate within the yarns.

Bazin, J. and Sasserod, S., 58ème Congrèss de l'Association des Chimistes de l'lndustrie Textile Science, Mullhouse, France. Oct. 25, 1991, discloses that a reduction in fuzz level which resulted in a dramatic reduction in pilling on both 100% cotton and polyester cotton blends could be obtained using cellulase.

U.S. Pat. No. 5,997,584 discloses a method of reducing the pilling propensity of polyester fabrics and/or garments, which method comprises treating the fabric or garment with a terephtalic acid diethyl ester hydrolytic enzyme and/or an ethyleneglycol dibenzyl ester hydrolytic enzyme, and which method is carried out in presence of a detergent.

### SUMMARY OF THE INVENTION

Pilling of fabric changes the aesthetic properties of textiles. The smoothness, color and general hand of fabric can be compromised. Therefore, it is an object of the present invention to provide an improved method of reducing the pilling propensity of polyester fabrics and garments. In particular, the invention provides that a group of ethyleneglycol dibenzyl ester (BEB) and/or terephtalic acid diethyl ester (ETE) hydrolytic enzymes are capable of reducing pilling propensity of polyester fabrics and garments without the presence of a detergent.

The inventors have found that enzymatic bio-polishing offers a durable finish for pill prevention. It was demonstrated (see Example 3) that ethyleneglycol dibenzyl ester (BEB) and/or terephtalic acid diethyl ester (ETE) hydrolytic enzymes are capable of reducing pilling propensity of polyester fabrics and garments without the presence of a detergent. More specifically, the inventors have demonstrated that ethyleneglycol dibenzyl ester (BEB) and/or terephtalic acid diethyl ester (ETE) hydrolytic enzymes within the group of esterases, preferably cutinases, are capable of reducing pilling propensity of polyester fabrics and garments without the presence of a detergent. Also the combination of ethyleneglycol dibenzyl ester (BEB) and/or terephtalic acid diethyl ester (ETE) hydrolytic enzymes was found to provide improved bio-polishing/pilling of polyester and cotton blended fabrics.

Furthermore, the treatment with ethyleneglycol dibenzyl ester (BEB) and/or terephtalic acid diethyl ester (ETE) hydrolytic enzymes is capable of color clarification of polyester fabrics and/or garments without the presence of a detergent.

From experiments with use of an ETE hydrolytic enzyme and/or a BEB hydrolytic enzyme for reducing the pilling propensity, it has been found that the method of the present invention allow for improvements in color clarification. Therefore, in a preferred embodiment, the method of the invention may be carried out simultaneously with conventional color clarification processes. Color clarification processes have been described in, e.g., EP 220,016; WO 91/17243; WO 89/09259; WO 91/19807; WO 94/07998 and WO 96/29397.

The term “color clarification”, as used herein, refers to preservation of the initial colors throughout multiple washing cycles by removing fuzz and pills from the surface of garment and/or fabric. The color clarification ability may be determined by measuring the reflectance of the textile.

Also, the method of the invention allows for improved soil release properties, in particular of oily stains, probably due to increased hydrophilicity of the polyester fibers.

Finally, the method of the invention was found to improve the antistatic properties of polyester fabrics and/or garments.

Accordingly, in its first aspect, the invention provides a method of reducing the pilling propensity of polyester fabrics and/or garments, which method comprises treating the fabric or garment with a terephtalic acid diethyl ester hydrolytic enzyme and/or an ethyleneglycol dibenzyl ester hydrolytic enzyme, and which method is carried out without the presence of a detergent.

In a second aspect, the invention provides a method of color clarification of polyester fabrics and/or garments, which method comprises treating the fabric or garment with a terephtalic acid diethyl ester hydrolytic enzyme and/or an ethyleneglycol dibenzyl ester hydrolytic enzyme, and which method is carried out without the presence of a detergent.

In a third aspect, the inventions provides a method of bio-polishing a polyester containing fabric or garment, which method comprises treating the fabric or garment with an enzyme selected from the group consisting of a terephtalic acid diethyl ester hydrolytic enzyme (ETE hydrolytic enzyme), an ethyleneglycol dibenzyl ester hydrolytic enzyme (BEB hydrolytic enzyme), and combinations of the foregoing, wherein said method is carried out without the presence of a detergent.

Other aspects of the invention will become apparent from the following detailed description and the claims.

### BRIEF DESCRIPTION OF THE DRAWING

FIG. 1 shows the effect of dosage on weight loss for esterase degradation of 100% polyester fabric. Conditions: 2 hours Launder-O-Meter treatment at 70° C., pH 8.

FIG. 2 shows the effect of dosage on pilling note at 2000 revolutions for 100% polyester fabric. Conditions: 2 hours Launder-O-Meter treatment at 70° C., pH 8.

FIG. 3 shows the effect of dosage on HPLC area count of polyester degradation peaks for 100% polyester fabric. Conditions: 2 hours Launder-O-Meter treatment at 70° C., pH 8.

### DETAILED DISCLOSURE OF THE INVENTION

The present invention is directed to a method of reducing the pilling propensity of polyester fabrics and/or garments. The invention furthermore provides a method of improving the color clarity of polyester fabrics and/or garments. Further, the invention also relates to a method of bio-polishing polyester and polyester containing fabrics or garments.

As used herein, the singular forms “a”, “an”, and “the” include plural references unless the context clearly dictates otherwise. Thus, for example, references to “terephtalic acid diethyl ester hydrolytic enzyme” include the use of one or more terephtalic acid diethyl ester hydrolytic enzymes.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned herein are incorporated herein by reference for the purpose of disclosing and describing the material for which the reference was cited in connection with.

Polyester Fabrics or Garments

The polyester fabrics and/or garments treated according to the method of the invention may be any fabric or fabric blend comprising polyester, including microdenier polyester. Actually, the pilling propensity is most pronounced in fabrics and/or garments comprising polyester fibers in blends with fibers of a different material. Polyester fabric blends include at least in context of the invention polyester and cellulosic blends, such as polyester and cotton blends. Other important polyester fabric blends (i.e., polyester containing blends) include polyester and wool blends, polyester and silk blends, polyester and acrylic blends, polyester and nylon blends, polyester and nylon and polyurethane blends, polyester and polyurethane blends (e.g., LYCRA™, SPANDEX™), rayon (viscose), cellulose acetate and tencel.

In a preferred embodiment the fabric is a fabric blend comprising more than 50% (w/w) of polyester, in particular more than 75% (w/w) of polyester, more than 90% (w/w) of polyester, or more than 95% (w/w) of polyester. In a most preferred embodiment, the process of the invention is applied to fabrics or garments consisting essentially of poly(ethylene terephthalate) polyester material, i.e., pure poly(ethylene terephthalate) polyester material.

Polyester Hydrolytic Enzymes

The method of the invention comprises treating the fabric or garment with a polyester hydrolytic enzyme. A certain group of enzymes are capable of hydrolysing terephtalic acid diethyl ester (ETE) and/or an ethyleneglycol dibenzyl ester (BEB), and therefore are polyesterhydrolytic enzymes.

Determination of which enzymes are ETE and/or BEB hydrolytic enzyme may be carried out as described in Example 1.

The method of the invention comprises treating the fabric or garment with an ETE hydrolytic enzyme and/or a BEB hydrolytic enzyme without the presence of a detergent. In a preferred embodiment, the method of the invention comprises treating the fabric or garment with an ETE hydrolytic enzyme. In another preferred embodiment, the method of the invention comprises treating the fabric or garment with a BEB hydrolytic enzyme. The BEB hydrolytic enzyme may in particular be a BEB¹⁰ hydrolytic enzyme or BEB³⁰ hydrolytic enzyme, as defined in Example 1, below. Preferably the ETE hydrolytic enzyme has a hydrolytic activity of at least 50%, more preferably of at least 90% and most preferably of at least 95%. Preferably the BEB¹⁰ or BEB³⁰ hydrolytic enzyme has a hydrolytic activity of at least 50%, more preferably at least 90% and most preferably at least 95%. In a most preferred embodiment both the BEB¹⁰, BEB³⁰ and ETE hydrolytic activity are at least 50%, more preferably at least 90% and most preferably at least 95%.

In an embodiment of the method of the invention the polyester or polyester containing fabric or garment is treated with an amount of ETE hydrolytic enzyme and/or a BEB hydrolytic enzyme in the range from about 0.0001 to 10 mg enzyme protein/ml treating liquor, preferably 0.0006 to 1 mg enzyme protein/ml treating liquor, especially in the range from 0.006-1.2 mg enzyme protein/ml treating liquor. ETE hydrolytic enzyme and/or a BEB hydrolytic enzyme may be derived from any convenient origin such as from bacterial, fungal, yeast, mammalian or plant origin.

Preferably the ETE hydrolytic enzyme and/or BEB hydrolytic enzyme is derived from a microbial source. In a more preferred embodiment, the ETE hydrolytic enzyme and/or BEB hydrolytic enzyme is derived from a strain of Candida, in particular, Candida antarctica and Candida cylindracea (syn. Candida rugosA), a strain of Humicola, in particular, Humicola insolens, e.g., Humicola insolens DSM 1800, a strain of Pseudomonas, in particular Pseudomonas cepacia.

As disclosed above, the enzymes may be derived from any origin, including, bacterial, fungal, yeast, mammalian or plant origin. The term “derived” means in this context that the enzyme may have been isolated from an organism where it is present natively, i.e. the identity of the amino acid sequence of the enzyme are identical to a native enzyme. The term “derived” also means that the enzymes may have been produced recombinantly in a host organism, the recombinant produced enzyme having either an identity identical to a native enzyme or having a modified amino acid sequence, e.g., having one or more amino acids which are deleted, inserted and/or substituted, i.e., a recombinantly produced enzyme which is a mutant and/or a fragment of a native amino acid sequence or an enzyme produced by nucleic acid shuffling processes known in the art. Within the meaning of a native enzyme are included natural variants. Furthermore, the term “derived” includes enzymes produced synthetically by, e.g., peptide synthesis. The term “derived” also encompasses enzymes which have been modified, e.g., by glycosylation, phosphorylation, or by other chemical modification, whether in vivo or in vitro. The term encompasses an enzyme that has been isolated from an organism where it is present natively, or one in which it has been expressed recombinantly in the same type of organism or another, or enzymes produced synthetically by, e.g., peptide synthesis. With respect to recombinantly produced enzymes the term “derived” refers to the identity of the enzyme and not the identity of the host organism in which it is produced recombinantly.

The enzymes may also be purified. The term “purified” as used herein covers enzymes free from other components from the organism from which it is derived. The term “purified” also covers enzymes free from components from the native organism from which it is derived. The enzymes may be purified, with only minor amounts of other proteins being present. The expression “other proteins” relate in particular to other enzymes. The term “purified” as used herein also refers to removal of other components, particularly other proteins and most particularly other enzymes present in the cell of origin of the enzyme of the invention. The enzyme may be “substantially pure,” that is, free from other components from the organism in which it is produced, that is, for example, a host organism for recombinantly produced enzymes. In preferred embodiment, the enzymes are at least 75% (w/w) pure, more preferably at least 80%, at least 85%, at least 90%, at least 95%, at least 96%, at least 97%, at least 98%, or at least 99% pure. In another preferred embodiment, the enzyme is 100% pure.

The enzyme may be in any form suited for the use in the treatment process, such as, e.g., in the form of a dry powder or granulate, a non-dusting granulate, a liquid, a stabilized liquid, or a protected enzyme. Granulates may be produced, e.g., as disclosed in U.S. Pat. No. 4,106,991 and U.S. Pat. No. 4,661,452, and may optionally be coated by methods known in the art. Liquid enzyme preparations may, for instance, be stabilized by adding stabilizers such as a sugar, a sugar alcohol or another polyol, lactic acid or another organic acid according to established methods. Protected enzymes may be prepared according to the method disclosed in EP 238,216.

The Treatment

The present invention provides a method of reducing the pilling propensity of polyester fabrics and/or garments. Further, the present invention provides a method of improving the color clarification of polyester fabrics and/or garments. Furthermore, the invention also relates to a method of bio-polishing polyester and polyester blend fabrics or garments.

The treatment according to the present invention may be carried out at conditions chosen to suit the method according to principles well known in the art. It will be understood that each of the reaction conditions, such as, e.g., concentration/dose of enzyme/substrate, pH, temperature, and time of treatment, may be varied, depending upon, e.g., the source of the enzyme, the type of substrate, the method in which the treatment is performed.

The process of the invention may further comprise the addition of one or more chemicals capable of improving the enzyme-substrate interaction (in order to improve the substrate's accessibility and/or dissolve reaction products), which chemicals may be added prior to, or simultaneously with the enzymatic treatment. Such chemicals may in particular be wetting agents and dispersing agents etc., or mixtures thereof.

Enzyme dosage must be a function of the enzyme(s) applied and the reaction time and conditions given. Preferably, the enzyme(s) may be dosed in a total amount of from about 0.05 micro grams per gram fabrics and/or garments to about 5000 micro grams per gram fabrics and/or garments.

The enzymatic treatment may preferably be carried out in the temperature range of from about 30° C. to about 100° C., more preferably from about 40° C. to about 90° C. The pH range may, dependent on the enzyme(s) applied, preferably be from about pH 5 to about pH 11, more preferably from about pH 7 to about pH 11. The reaction time may preferably be in the range of from about 15 minutes to about 3 hours.

In a preferred embodiment, the method of the invention is carried out in the presence of other enzymes, in particular, a proteolytic enzyme, a lipolytic enzyme, a cellulytic enzyme, an amylolytic enzyme, an oxidase enzyme, or a peroxidase enzyme, or mixtures hereof.

The bio-polishing treatment according to the invention comprises treating polyester or polyester containing fabrics or garments with an enzyme selected from the group consisting of a terephtalic acid diethyl ester hydrolytic enzyme (ETE hydrolytic enzyme), an ethyleneglycol dibenzyl ester hydrolytic enzyme (BEB hydrolytic enzyme), and combinations of the foregoing, wherein said method is carried out without the presence of a detergent.

The polyester fabrics or garments may in one embodiment be a polyester fabric consists of 100% polyester or essentially 100% polyester. In another embodiment the polyester containing fabric or garment is a polyester blend including any of the fabrics or garments mentioned in the “Polyester Fabrics or Garments” section above.

In a preferred embodiment the fabric or garment bio-polishing is carried out in the presence of a cellulytic enzyme, such as an endoglucanase, especially a fungal endoglucanase. However, further enzymes may be added. In an embodiment the fabric or garment is further treated with an enzyme selected from the group consisting of proteases, amylases, other cellulases, peroxidases, oxidases, and pectinases, lipases other than ETE or BEB hydrolyases, and combinations of any of the foregoing.

Detergent

In the context of this invention, a detergent is synonymous with a surfactant, e.g., a nonionic surfactant, an anionic surfactant, a cationic surfactant, an ampholytic surfactant, a zwitterionic surfactant, and a semi-polar surfactant, or a mixture hereof.

Other Enzymes

The polyester hydrolytic enzyme of the invention may be added in combination with other enzyme(s).

Such enzymes include other proteases, lipases, amylases, cellulases, peroxidases and oxidases.

Proteases

Any protease suitable for use in alkaline solutions can be used. Suitable proteases include those of animal, vegetable or microbial origin. Microbial origin is preferred. Chemically or genetically modified mutants are included. The protease may be a serine protease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g., of porcine or bovine origin) and the Fusarium protease described in WO 89/06270.

Preferred commercially available protease enzymes include those sold under the trade names ALCALASE™, SAVINASE™, PRIMASE™, DURAZYM™, and ESPERASE™ by Novozymes A/S (Denmark), those sold under the tradename MAXATASE™, MAXACAL™, MAXAPEM™, PROPARASE™, PURAFECT™ and PURAPECT™ OXP by Genencor International Inc., (USA), and those sold under the tradename OPTICLEAN™ and OPTIMASE™ by Solvay Enzymes. Protease enzymes may be incorporated into the compositions in accordance with the invention at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

Lipases

Any lipase suitable for use in alkaline solutions can be used. Suitable lipases include those of bacterial or fungal origin. Chemically or genetically modified mutants are included.

Examples of useful lipases include a Humicola lanuginosa lipase, e.g., as described in EP 258 068 and EP 305 216, a Rhizomucor miehei lipase, e.g., as described in EP 238 023, a Candida lipase, such as a C. antarctica lipase, e.g., the C. antarctica lipase A or B described in EP 214 761, a Pseudomonas lipase such as a P. alcaligenes and P. pseudoalcaligenes lipase, e.g., as described in EP 218 272, a P. cepacia lipase, e.g., as described in EP 331 376, a P. stutzeri lipase, e.g., as disclosed in GB 1,372,034, a P. fluorescens lipase, a Bacillus lipase, e.g., a B. subtilis lipase (Dartois et al., (1993), Biochemica et Biophysica acta 1131, 253-260), a B. stearothermophilus lipase (JP 64/744992) and a B. pumilus lipase (WO 91/16422).

Furthermore, a number of cloned lipases may be useful, including the Penicillium camembertii lipase described by Yamaguchi et al., (1991), Gene 103, 61-67), the Geotricum candidum lipase (Schimada, Y. et al., (1989), J. Biochem., 106, 383-388), and various Rhizopus lipases such as a R. delemar_lipase (Hass, M. J et al., (1991), Gene 109, 117-113), a R. niveus lipase (Kugimiya et al., (1992), Biosci. Biotech. Biochem. 56,716-719) and an R. oryzae lipase.

Especially suitable lipases are lipases such as M1 LIPASE™, LUMA FAST™ and LIPOMAX™ (Genencor International Inc, USA), LIPOLASE™ and LIPOLASE ULTRA™ (Novozymes A/S, Denmark), and LIPASE P “Amano” (Amano Pharmaceutical Co. Ltd.).

The lipases are normally incorporated in the composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

Amylases

Any amylase (alpha and/or beta) suitable for use in alkaline solutions can be used. Suitable amylases include those of bacterial or fungal origin. Chemically or genetically modified mutants are included. Amylases include, for example, alpha-amylases obtained from a special strain of B. licheniformis, described in more detail in GB 1,296,839. Commercially available amylases are DURAMYL™, TERMAMYL™, FUNGAMYL™ and BAN™ (available from Novozymes A/S, Denmark) and RAPIDASE™ and MAXAMYL P™ (available from Genencor International Inc., USA).

The amylases are normally incorporated in the composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

Cellulases

In the present context, the term “cellulase or “cellulolytic enzyme” refers to an enzyme, which catalyses the degradation of cellulose to glucose, cellobiose, triose and other cellooligosaccharides. Cellulose is a polymer of glucose linked by beta-1,4-glucosidic bonds. Cellulose chains form numerous intra- and intermolecular hydrogen bonds, which result in the formation of insoluble cellulose microfibrils. Microbial hydrolysis of cellulose to glucose involves the following three major classes of cellulases: endo-1,4-beta-glucanases (EC 3.2.1.4), which cleave beta-1,4-glucosidic links randomly throughout cellulose molecules; cellobiohydrolases (EC 3.2.1.91) (exoglucanases), which digest cellulose from the nonreducing end; and beta-glucosidases (EC 3.2.1.21), which hydrolyse cellobiose and low-molecular-mass cellodextrins to release glucose. Most cellulases consist of a cellulose-binding domain (CBD) and a catalytic domain (CAD) separated by a linker rich in proline and hydroxy amino acid residues. In the specification and claims, the term “endoglucanase” is intended to denote enzymes with cellulolytic activity, especially endo-1,4-beta-glucanase activity, which are classified in EC 3.2.1.4 according to the Enzyme Nomenclature (1992) and are capable of catalyzing (endo)hydrolysis of 1,4-beta-D-glucosidic linkages in cellulose, lichenin and cereal beta-D-glucans including 1,4-linkages in beta-D-glucans also containing 1,3-linkages. Any cellulase suitable for use in alkaline solutions can be used. Suitable cellulases include those of bacterial or fungal origin. Chemically or genetically modified mutants are included. Suitable cellulases are disclosed in U.S. Pat. No. 4,435,307, which discloses fungal cellulases produced from Humicola insolens. Especially suitable cellulases are the cellulases having color care benefits. Examples of such cellulases are cellulases described in European patent application No. 0 495 257, WO 91/17243 and WO 96/29397.

Commercially available cellulases include CELLUZYME™ and DENIMAX™ produced by a strain of Humicola insolens, (Novozymes A/S), and KAC-500(B)™ (Kao Corporation).

Cellulases are normally incorporated in the composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

In an embodiment of the method of the invention the cellulase may be used in a concentration in the range from 0.001-10 mg enzyme protein/ml solution, preferably 0.005-0.3 mg enzyme protein/ml solution, especially 0.001-0.003 mg enzyme protein/ml solution.

Peroxidases/Oxidases

Peroxidase enzymes are used in combination with hydrogen peroxide or a source thereof (e.g., a percarbonate, perborate or persulfate). Oxidase enzymes are used in combination with oxygen. Both types of enzymes are used for “solution bleaching”, i.e. to prevent transfer of a textile dye from a dyed fabric to another fabric when said fabrics are washed together in a wash liquor, preferably together with an enhancing agent as described in e.g. WO 94/12621 and WO 95/01426. Suitable peroxidases/oxidases include those of plant, bacterial or fungal origin. Chemically or genetically modified mutants are included.

Peroxidase and/or oxidase enzymes are normally incorporated in the composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

Mixtures of the above mentioned enzymes are encompassed herein, in particular a mixture of a protease, an amylase, a lipase and/or a cellulase.

The enzyme, or any other enzyme incorporated in the composition, is normally incorporated in the composition at a level from 0.00001% to 2% of enzyme protein by weight of the composition, preferably at a level from 0.0001% to 1% of enzyme protein by weight of the composition, more preferably at a level from 0.001% to 0.5% of enzyme protein by weight of the composition, even more preferably at a level from 0.01% to 0.2% of enzyme protein by weight of the composition.

Materials and Methods

Enzymes:

Cutinase variant A is derived from Humicola insolens DSM 1800 and is disclosed in WO 01/92502 and includes the following substitutions: E6Q, A14P, E47K, R51P, E179Q, GBD, N15D, S48E, A88H, N91H, A130V, R189V, T29M, T1661, L167P.

Cutinase variant B is derived from Humicola insolens DSM 1800 and is disclosed in WO 01/92502 and includes the following substitutions: E6Q, A14P, E47K, R51P, E179Q, G8D, N15D, S48E, A88H, N91H, A130V, R189V.

Cellulytic enzyme: 43 kd endoglucanase (EG V) derived from Humicola insolens DSM 1800, disclosed in WO 91/17243 as SEQ ID NO: 2.

Fabric

100% Dacron type 54 woven fabric and a 50%/50% polyester cotton single knit were obtained from TestFabrics Inc. The 100% polyester fabric was scoured, rinsed and dried as a preparation to enzymatic treatment. The blended fabric was used as received. Experimental swatches were cut to 14×14 cm. All swatches were conditioned overnight at a constant temperature and humidity (21±20° C., 65±2% RH (Relative Humidity). The weight was then measured and recorded.

Methods:

Bio-Polishing

Bio-polishing was carried out in a Launder-O-Meter (LOM) LP2 from Atlas Electric Devices Company. 20 Steel balls, buffer and enzyme were added in 500 mL steel beakers. 50 mM sodium bicarbonate buffer was adjusted to pH 8 and used for all experiments. The liquor ratio was 20:1 and the enzymes were dosed as U/ml (LU or ECU per liquor volume). Two swatches with a total weight of 7.0±0.1 g were used in each beaker and each treatment was run in duplicate. The beakers were loaded into a preheated Launder-O-Meter at 70° C. and incubated at 42 rpm for a specified time.

Following enzyme treatment, the residual enzyme activity on the swatches was inactivated at 80° C. in 2 g/L soda ash solution for 10 minutes. After inactivation, the swatches were rinsed and centrifuged in a conventional home washer and tumble dried for 60 minutes. All swatches were conditioned overnight at a constant temperature and humidity (21° C.±2° C. 65±2% RH).

Weight Loss

Final swatch weight was measured and recorded after conditioning to determine weight loss. A mean weight loss was calculated by averaging the weight loss data for all swatches in one treatment type.

Pilling

Pilling was measured according to ASTM D3786-87 (Pilling Resistance and Other Related Surface Changes of Textile Fabrics-Martindale Pressure Tester Method). A swatch from each beaker was tested and evaluated after 125, 500 and 2000 revolutions on a Nu-Martindale Abrasion and Pilling Tester from James H. Heal & Co. Ltd. A pilling note was obtained by visually comparing to a standard on a scale from 1-5, where 5 is no pilling and 1 is severely pilled. A mean pilling note was calculated by averaging all swatches treated under the same conditions.

HPLC Analysis

Liquor samples were taken from each beaker after Launder-O-Meter incubation for HPLC analysis. The samples were filtered and loaded into vials. The samples were then injected on an Agilent 1100 series HPLC and detected with a variable wavelength detector at 254 nm at 25° C. The mobile phase was a combination of solvent A—filtered deionized water plus 0.1% trifluoroacetic acid and solvent B—100% acetonitrile. A gradient was used where solvent B increased from initial concentration of 10% up to 95% at the end of the 19 minute run time. An Adsorbosil C₁₈ column from Alltech (USA) was used. The flow rate was 0.8 ml/minute. After each injection the needle was rinsed in dimethylformamide and the column was allowed to equilibrate for 5 minutes at initial conditions. Peak area counts for known degradation products of polyester were averaged for samples treated under the same conditions.

Lipase Activity (LU)

The esterase activity was measured according to Novozymes analytical method 2001-07992-01 hereby incorporated by reference and available from Novozymes A/S, Denmark, on request. In this assay, glycerol tributyrate was incubated with the esterase composition in 0.1 mM glycine buffer (pH 7) at 30° C. over time. The lipase unit, or LU, is the amount of enzyme which releases 1 micro mol of titratable butyric acid per minute. The incubation is held for a minimum of two minutes and the resulting activity is calculated and expressed in LU/g.

Cellulase Activity (ECU)

The cellulase activity was measured according to Novozymes analytical method 302.02/01 hereby incorporated by reference and available from Novozymes A/S, Denmark, on request. In this assay, carboxymethylcellulose (CMC) was incubated with the cellulase composition in 0.1 M phosphate buffer (pH 7.5) at 40° C. for 30 minutes. The reduction in viscosity was determined by a vibration viscometer and the result was compared to a standard cellulase and expressed in endocellulase units as ECU/g.

Apparatus

Improvements in pilling resistance may be determined using the Martindale pilling tester (Swiss standard SN 198525) hereby incorporated by reference).

### EXAMPLES

The invention is further illustrated with reference to the following examples which are not intended to be in any way limiting to the scope of the invention as claimed.

### Example 1

### Hydrolytic Activity

This example described an assay for determining the terephtalic acid diethyl ester (ETE) and/or an ethyleneglycol dibenzyl ester (BEB) hydrolytic activity of an enzyme.

ETE Hydrolytic Activity

An ETE hydrolytic enzyme of the invention is an enzyme capable of hydrolyzing terephtalic acid diethyl ester (ETE), as determined by the following assay.

In a test tube, 0.250 ml of 0.20 M glycylglycine pH 8.5, and 0.250 ml of 10.0 mM terephthalic acid diethyl ester (ETE) in 1,4-dioxane, is added to 2.000 ml of de-ionized water.

The mixture is pre-incubated under stirring at 30° C. for approximately 15 minutes, followed by the addition of 25.0 micro g of enzyme in the lowest possible volume. This mixture is then subjected to incubation under stirring at 30° C. for 16 hours.

The reaction mixture is analyzed on a reverse phase HPLC, ODS (octa dodecyl silicate) column, and eluted with increasing concentration of acetonitrile and decreasing concentration of 200 mM NaPO₄, pH 3.0.

Detection of the reaction products is carried out spectrophotometrically at 240 nm, at which wavelength terephtalic acid and terephtalate derivatives adsorb.

BEB Hydrolytic Activity

A BEB hydrolytic enzyme of the invention is an enzyme capable of hydrolyzing ethyleneglycol dibenzyl ester (BEB). Dependent on the amount of dioxane present in the assay (BEB is only partially dissolved in a 10% dioxane solution, but fully dissolved in a 30% dioxane solution), the BEB hydrolytic enzyme of the invention may be a BEB¹⁰ hydrolytic enzyme or a BEB³⁰ hydrolytic enzyme, as determined by the following assays.

BEB¹⁰ Hydrolytic Activity

In a test tube, 0.250 ml of 0.20 M glycylglycine pH 8.5, and 0.250 ml of 10.0 mM ethyleneglycol dibenzyl ester (BEB) in 1,4-dioxane, is added to 2.000 ml of de-ionized water.

The mixture is pre-incubated under stirring at 30° C. for approximately 15 minutes, followed by the addition of 25.0 micro g of enzyme in the lowest possible volume. This mixture is then subjected to incubation under stirring at 30° C. for 16 hours.

The reaction mixture is analyzed on a reverse phase HPLC, ODS (octa dodecyl silicate) column, and eluted with increasing concentration of acetonitrile and decreasing concentration of 200 mM NaPO₄, pH 3.0.

Detection of the reaction products is carried out spectrophotometrically at 240 nm, at which wavelength terephtalic acid and terephtalate derivatives adsorb.

BEB³⁰ Hydrolytic Activity

In a test tube, 0.250 ml of 0.20 M glycylglycine pH 8.5, 0.250 ml of 10.0 mM ethyleneglycol dibenzyl ester (BEB) in 1,4-dioxane, and 0.500 ml of 1,4-dioxane, is added to 1.500 ml of de-ionized water. The mixture is pre-incubated under stirring at 30° C. for approximately 15 minutes, followed by the addition of 25.0 micro g of enzyme in the lowest possible volume. This mixture is then subjected to incubation under stirring at 30° C. for 16 hours.

The reaction mixture is analyzed on a reverse phase HPLC, ODS (octa dodecyl silicate) column, and eluted with increasing concentration of acetonitrile and decreasing concentration of 200 mM NaPO₄, pH 3.0.

Detection of the reaction products is carried out spectrophotometrically at 240 nm, at which wavelength terephtalic acid and terephtalate derivatives adsorb.

Microbial Sources

A number of enzymes from different microbial sources were subjected to the assay for determining BEB and ETE hydrolytic activity, and the results obtained are presented in Table 1, below:

TABLE 1
Enzymes having BEB and/or ETE Hydrolytic Activity; % Degradation
of Substrate.

| Enzyme | Substrate | | |
|---|---|---|---|
| Microbial Source | BEB³⁰ | BEB¹⁰ | ETE |
| Humicola insolens¹⁾ | 100 | 100 | 95 |
| Candida antarctica²⁾ | 60 | 100 | 100 |
| Pseudomonas cepacia³⁾ | 95 | — | 60 |
| Candida cylindracea⁴⁾ | 0 | 100 | 15 |
| GA⁵⁾ | 0 | 0 | 5 |

¹⁾Humicola insolens cutinase (actually a lipase also having cutinase activity) obtained from the strain DSM 1800 as described in Example 2 of U.S. Pat. No. 4,810,414.
²⁾Candida antarctica Component B obtained as described in Example 10 of WO 88/02775.
³⁾Pseudomonas cepacia obtained as described in EP 331,376.
⁴⁾Candida cylindracea (syn. Candida rugosa) lipase obtained from Nippon Oil & Fats Co. Ltd., Japan).
⁵⁾Glucosaminated LIPOLASE ™ obtained as described in Example 7A of WO 95/09909.

### Example 2

### Reduced Pilling Propensities

140 ml 50 mM Sodium Bicarbonate buffer pH 8 was added to each Launder-O-Meter beaker including 20 steel balls. The beakers were equilibrated at 70° C. Two woven 100% polyester swatches (approx. 14×14 cm each) were added to each Launder-O-Meter beaker. Enzyme (Humicola insolens cutinase) was added at different dosages and with and without the addition of Triton X-100 dosed at 1 g/L including a blank without enzyme. The swatches were incubated for 4 hours at 70° C. in the Launder-O-Meter turning at 42 rpm. After incubation the swatches were given a short rinse in a household laundry machine and tumble dried for 1 hour.

Pilling measurements are measured using the Martindale pilling tester (Swiss standard SN 198525).

The results are shown in table 2.

TABLE 2
Pilling note for 100% polyester fabric

| | | | Cutinase | |
|---|---|---|---|---|
| Revolutions | Blank - | Cutinase | 50 LU/mL and | 1 g/L Triton |
| tested | no enzyme | 50 LU/mL | 1 g/L Triton X-100 | X-100 only |
| 125 rev. | 2.75 | 4 | 3.25 | 3.5 |
| 500 rev. | 2 | 3.25 | 2.5 | 2.75 |
| 2000 rev. | 1.5 | 3.25 | 2 | 2.5 |

A pilling note is obtained by visually comparing to a standard on a scale from 1-5, where 5 is no pilling and 1 is severely pilled. A mean pilling note is calculated by averaging all swatches treated under the same conditions.

### Example 3

### Bio-Polishing of 100% Polyester

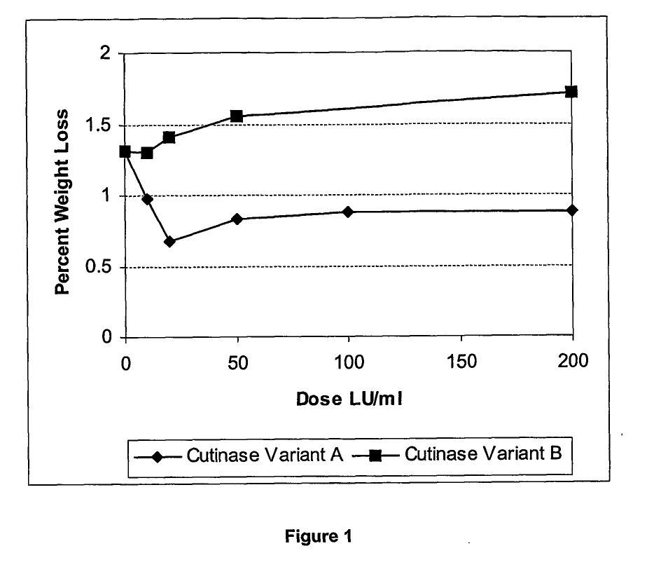

The bio-polishing effect of two Humicola insolens ETE and/or BEB hydrolytic enzymes (in the form of two cutinase variants, referred to as cutinase variant A and B, respectively), were tested on 100% polyester as described in the “Materials & Methods” section. The 100% polyester fabric was scoured, rinsed and dried as a preparation to enzymatic treatment. Initially the polyester fabric was enzymatically degraded with cutinase variant A and cutinase variant B, respectively. Cutinase variant B gave higher weight loss than that of cutinase variant A, whereas cutinase variant A gave little to no weight loss compared to a blank (see FIG. 1). A blank is defined as a treatment performed where no enzyme is added.

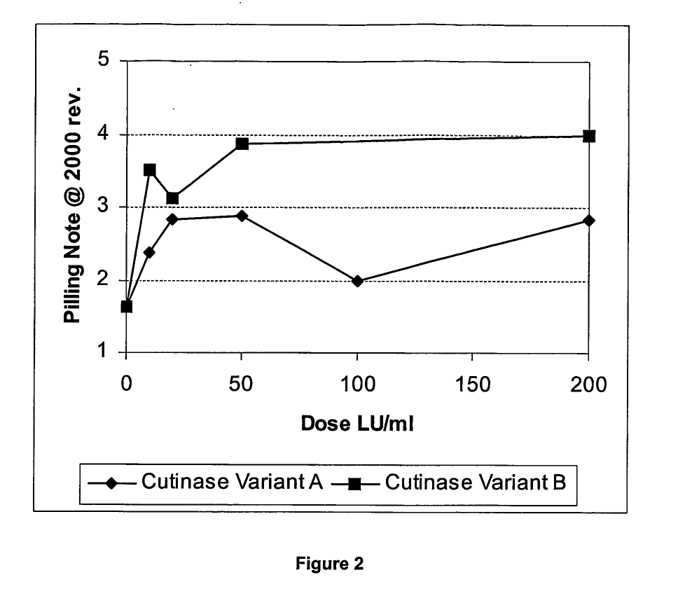

Both enzymes gave improvement on pilling note compared to the blank at 2000 revolutions (see FIG. 2). Although there was little to no weight loss for cutinase variant A, an improvement in pilling note was observed as compared to the blank.

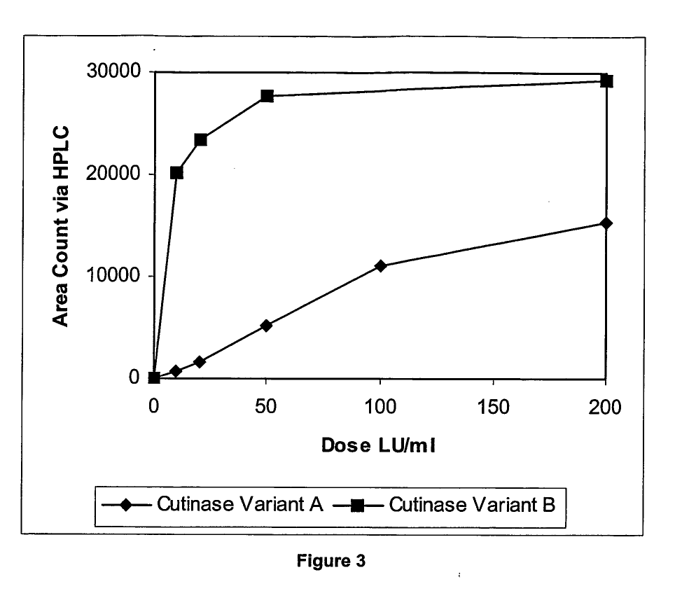

Additionally, HPLC results were measured to detect enzymatic degradation (see FIG. 3). Cutinase variant B shows considerably higher degradation according to HPLC area count of degradation products of polyester. This correlates with higher pilling note and weight loss. However, FIG. 3 does illustrate that both enzymes are acting on the polyester as a substrate and the pilling prevention data is an enzymatic hydrolysis effect.

The test demonstrates that 100% polyester fabric can be treated with ETE and/or BEB hydrolytic enzymes to impart a durable bio-polished finish without the presence of a detergent.

### Example 4

### Bio-Polishing of Polyester/Cotton Blends

The bio-polishing effect of an ETE and/or BEB hydrolytic enzyme (cutinase variant A) in combination with a 43 kD cellulase from Humicola insolens, DSM 1800, was tested on a 50%/50% polyester cotton as described in the “Materials & Methods” section. The blended fabric was used untreated.

Two dose response trials were performed. The first dose response was maintaining a 0.75 ECU/ml dose of cellulase and increasing the dosage of Cutinase variant A from 0 to 50 LU/ml. The second dose response trial was maintaining a 50 LU/ml dose of cutinase variant A and increasing the dosage of cellulase from 0 to 1 ECU/ml.

All data from polyester/cotton blend bio-polishing is shown is Table 3.

TABLE 3
Bio-Polishing of 50%/50% Polyester/Cotton Blend, LOM treatment,
2 hours, pH 8 at 70° C.

| Enzyme Treatment | | Evaluation | | |
|---|---|---|---|---|
| | Dose Cutinase | | | HPLC area |
| Dose Cellulase | variant A | Weight | Pilling at | count at |
| (ECU/ml) | (LU/ml) | Loss % | 2000 rev. | 254 nm |
| 0 | 0 | 1.0 | 1.25 | 9 |
| 0.75 | 0 | 1.1 | 2.5 | 8 |
| 0.75 | 10 | 1.3 | 3 | 1888 |
| 0.75 | 20 | 1.4 | 2.3 | 2713 |
| 0.75 | 30 | 1.4 | 3 | 3058 |
| 0.75 | 50 | 1.6 | 3 | 3503 |
| 0 | 50 | 1.3 | 1.5 | 3699 |
| 0.25 | 50 | 1.6 | 2.8 | 3616 |
| 0.5 | 50 | 1.6 | 2.5 | 3524 |
| 0.75 | 50 | 1.6 | 3 | 3530 |
| 1 | 50 | 1.7 | 3 | 3559 |

The weight loss measured for each dose response increased with increased dosage of both enzymes.

Both cellulase and Cutinase variant A gave an improvement in pilling note as compared to the blank. When both enzymes are combined, the most significant improvement in pilling note is observed at almost all doses evaluated.

HPLC results were measured to detect enzymatic degradation of the polyester polymer due to cutinase activity. The area count of degradation products of polyester increases as the enzyme dose increases. As the cellulase dose increases, the area count does not change because the dosage of Cutinase variant A was constant.

The test demonstrates that a polyester cotton blend fabric can be treated with a cellulase combined with a ETE and/or BEB hydrolytic enzyme to impart a durable bio-polished finish without the presence of a detergent.

1. A method of reducing the pilling propensity of a polyester fabric or garment, which comprises treating the fabric or garment with an enzyme selected from the group consisting of a terephtalic acid diethyl ester hydrolytic enzyme (ETE hydrolytic enzyme), an ethyleneglycol dibenzyl ester hydrolytic enzyme (BEB hydrolytic enzyme), and combinations of the foregoing, wherein said method is carried out without the presence of a detergent.

2. The method according to claim 1, wherein the fabric or garment is treated with a terephtalic acid diethyl ester hydrolytic enzyme (ETE hydrolytic enzyme).

3. The method according to claim 1, wherein the fabric or garment is treated with an ethyleneglycol dibenzyl ester hydrolytic enzyme (BEB hydrolytic enzyme).

4. The method according to claim 1, further comprising treating said fabric or garment with an enzyme selected from the group consisting of proteases, amylases, cellulases, peroxidases, oxidases, pectinases, lipases other than ETE or BEB hydrolyases, and combinations of any of the foregoing.

5. The method according to claim 4, wherein said fabric or garment is treated with a cellulytic enzyme.

6. A method of color clarification of a polyester fabric or garment, which comprises treating the fabric or garment with an enzyme selected from the group consisting of a terephtalic acid diethyl ester hydrolytic enzyme (ETE hydrolytic enzyme), an ethyleneglycol dibenzyl ester hydrolytic enzyme (BEB hydrolytic enzyme), and combinations of the foregoing, wherein said method is carried out without the presence of a detergent.

7. The method according to claim 6, wherein the fabric or garment is treated with a terephtalic acid diethyl ester hydrolytic enzyme (ETE hydrolytic enzyme).

8. The method according to claim 6, wherein the fabric or garment is treated with an ethyleneglycol dibenzyl ester hydrolytic enzyme (BEB hydrolytic enzyme).

9. The method according to claim 6, further comprising treating said fabric or garment with an enzyme selected from the group consisting of proteases, amylases, cellulases, peroxidases, oxidases, and pectinases, lipases other than ETE or BEB hydrolyases, and combinations of any of the foregoing.

10. The method according to claim 6, wherein said fabric or garment is treated with a cellulytic enzyme.

11. A method of bio-polishing polyester containing fabrics or garments, which method comprises treating said fabric or garment with an enzyme selected from the group consisting of a terephtalic acid diethyl ester hydrolytic enzyme (ETE hydrolytic enzyme), an ethyleneglycol dibenzyl ester hydrolytic enzyme (BEB hydrolytic enzyme), and combinations of the foregoing, wherein said method is carried out without the presence of a detergent.

12. The method of claim 11, wherein the polyester containing fabric or garment consists of essentially 100% polyester.

13. The method of claim 11, wherein the polyester fabric or garment is a polyester blend, such as a polyester and cellulosic blend, including polyester and cotton blends; a polyester and wool blend; a polyester and silk blend; a polyester and acrylic blend; a polyester and nylon blend; a polyester, nylon and polyurethane blend; a polyester and polyurethane blend, rayon (viscose), cellulose acetate and tencel.

14. The method according to claim 11, wherein said fabric or garment is further treated with a cellulytic enzyme.

15. The method according to claim 11, wherein the fabric or garment is treated with a terephtalic acid diethyl ester hydrolytic enzyme (ETE hydrolytic enzyme).

16. The method according to claim 11, wherein the fabric or garment is treated with an ethyleneglycol dibenzyl ester hydrolytic enzyme (BEB hydrolytic enzyme).

17. The method according to claim 11, further comprising treating said fabric or garment with an enzyme selected from the group consisting of proteases, amylases, other cellulases, peroxidases, oxidases, and pectinases, lipases other than ETE or BEB hydrolyases, and combinations of any of the foregoing.
